(19) United States
(12) Patent Application Publication
(10) Pub. No.: US 2009/0169070 A1
(43) Pub. Date: Jul. 2, 2009

(54) Control of electronic device by using a person's fingerprints

(75) Inventor: Anthony Fadell, Portola Valley, CA (US)

Correspondence Address: KRAMER LEVIN NAFTALIS & FRANKEL LLP, 1177 Avenue of the Americas, New York, NY, 10036, US

(73) Assignee: Apple Inc., Cupertino, CA (US)

(21) Appl. No.: 12/070,042

(22) Filed: Feb. 13, 2008

Related U.S. Application Data
(60) Provisional application No. 61/009,522, filed on Dec. 28, 2007.

(51) Int. Cl. G06K 9/00

(52) U.S. Cl. 382/124

(57) ABSTRACT

The present invention can include systems and methods for controlling an electronic device by detecting and using a person's fingerprints. A device can store user input signatures, including fingerprint signatures. The user input signatures can, in turn, be associated with user-selectable commands. When a user provides user input (including fingerprints) to the electronic device that matches one of the stored user input signatures, the device can initiate the associated user-selectable command.

### CROSS-REFERENCE TO RELATED APPLICATIONS

This application claims the benefit of U.S. Provisional Patent Application No. 61/009,522, filed Dec. 28, 2007, which is hereby incorporated by reference herein in its entirety.

### FIELD OF THE INVENTION

The present invention relates to systems and methods for controlling an electronic device. In particular the present invention relates to systems and methods for controlling an electronic device by detecting and using a person's fingerprints.

### BACKGROUND OF THE INVENTION

Many conventional electronic devices may incorporate user interfaces that require a user to look at the interface in order to interact with it. For example, many currently available electronic devices have input mechanisms (e.g., buttons and dials) that require visual identification before the users can manipulate the input mechanisms and, thereby, control operation of the device.

Unfortunately, in some situations, a user may not be able to or it may not be safe for the user to do so. For example, a consumer may not be able to look at a user interface while the user is performing some activities (e.g., driving or exercising). Likewise, it may be difficult for those who are visually-impaired to interact with electronic devices that require users to look at the user interface. Without being able to look at the device, the user may not be able to visually identify the correct user input mechanism to manipulate in order to cause the device to initiate a desired command.

Furthermore, as people become increasingly active and mobile, they are demanding increasingly smaller electronic devices. The design of smaller devices can be limited, however, by user interfaces that require numerous user input mechanisms to provide an appropriate scope of user interaction with the devices.

### SUMMARY OF THE INVENTION

The present invention can include systems and methods for controlling an electronic device by detecting and using a person's fingerprints. For example, a device can store unique compositions of a user's fingerprints as fingerprint signatures, which can, in turn, be associated with user-selectable commands. When a user provides a composition of fingerprints to the electronic device that matches one of the fingerprint signatures, the device can initiate the associated command. A composition of fingerprints can comprise a group of one or more fingerprints. This can include, for example, a fingerprint from one finger or fingerprints from multiple fingers. A composition having multiple fingerprints can include, for example, fingerprints obtained from a user pressing one finger multiple times to a fingerprint sensor or by a user pressing different fingers to one or more fingerprint sensors.

In another embodiment of the present invention, a user-selectable command can be associated with a user input signature that has both a fingerprint signature and a non-fingerprint signature. The electronic device can be configured to initiate the user-selectable command after it detects and matches user input to the associated fingerprint signature and non-fingerprint signature. The non-fingerprint signature can include, for example, verbal input, a conventional button input, input on a multi-touch interface (e.g., similar to that incorporated into an iPhone™ sold by Apple Inc. of Cupertino, Calif.), any other type of user input, or any combination thereof.

In comparison with a conventional device that requires a user to initiate user-selectable commands by manipulating a button or dial, the present invention can reduce and, in some embodiments, eliminate the need for a user to look at a device's user interface in order to interact with and control the device. Furthermore, the present invention can reduce the size of an electronic device by replacing a plurality of conventional user input mechanisms (e.g., buttons and/or dials) with a fewer number of fingerprint sensors.

In another embodiment, a device of the present invention also can use a user's fingerprints for authentication purposes, in addition to controlling operation of the device. For example, responsive to a positive authentication determination, a device of the present invention can permit a user to access one or more functions of the electronic device and/or stored content.

Systems and methods also are provided for a registration process to associate unique compositions of a user's fingerprints with user-selectable commands.

### BRIEF DESCRIPTION OF THE DRAWINGS

The above and other advantages of the present invention will be apparent upon consideration of the following detailed description, taken in conjunction with accompanying drawings, in which like reference characters refer to like parts throughout, and in which:

FIG. 1 is an illustrative electronic device in accordance with one embodiment of the present invention;

FIG. 2 is an illustrative block diagram of the electronic device of FIG. 1 in accordance with one embodiment of the present invention;

FIG. 3 is an illustrative registration process for associating unique compositions of a user's fingerprints with user-selectable commands in accordance with one embodiment of the present invention;

FIG. 4 is an illustrative process for controlling an electronic device using a person's fingerprints in accordance with one embodiment of the present invention;

FIG. 5 is an illustrative process for controlling an electronic device using a person's fingerprints and other user input in accordance with one embodiment of the present invention;

FIGS. 6A and 6B show a second illustrative electronic device in accordance with one embodiment of the present invention;

FIG. 7 is an illustrative database in which user-selectable commands are associated with different parameters in accordance with one embodiment of the present invention; and

FIG. 8 shows an illustrative electronic system in accordance with one embodiment of the present invention.

### DETAILED DESCRIPTION OF THE INVENTION

Conventional electronic devices typically have user interfaces that require a person to look at the interface in order to interact with it. For example, in order to select and cause the device to initiate a user-selectable command, the user may have to visually identify the appropriate user input mechanism among a multitude of user input mechanisms on the interface. Unfortunately, this design may be inconvenient for users in certain situations in which the user cannot view the interface or dare not shift their attention to the interface.

Furthermore, as people become increasingly active and mobile, they are demanding increasingly smaller electronic devices. The design of smaller devices can be limited, however, by user interfaces that require numerous user input mechanisms to provide an appropriate scope of user interaction with the devices.

Each fingerprint on a person's hands is unique. The present invention takes advantage of this to reduce or eliminate the need for users to visually identify individual user input mechanisms and to consolidate the functionality of multiple user input mechanisms. For example, devices of the present invention can associate user-selectable commands to fingerprint signatures, which can be stored unique compositions of a user's fingerprints. To cause an electronic device to initiate any one of these associated commands, a user can merely provide the appropriate composition of his fingerprints to one or more fingerprint sensors as user input. Once the device detects and matches the fingerprint(s) to a fingerprint signature, the device can initiate the associated command. In some embodiments, one or more user-selectable commands may be associated with user input signatures having both fingerprint and non-fingerprint signatures. The non-fingerprint signature can include, for example, a predetermined verbal input, a conventional button input, any other type of user input, or any combination thereof. To cause any one those user-selectable commands to initiate, the user can provide the appropriate composition of fingerprints to the device along with other required user input.

As used herein, a user-selectable command is a command for controlling an electronic device that a user can choose to initiate. A device may be configured to initiate some user-selectable commands only responsive to a user selection; but some user-selectable commands also can be initiated responsive to either a user selection or automatically responsive to a device status.

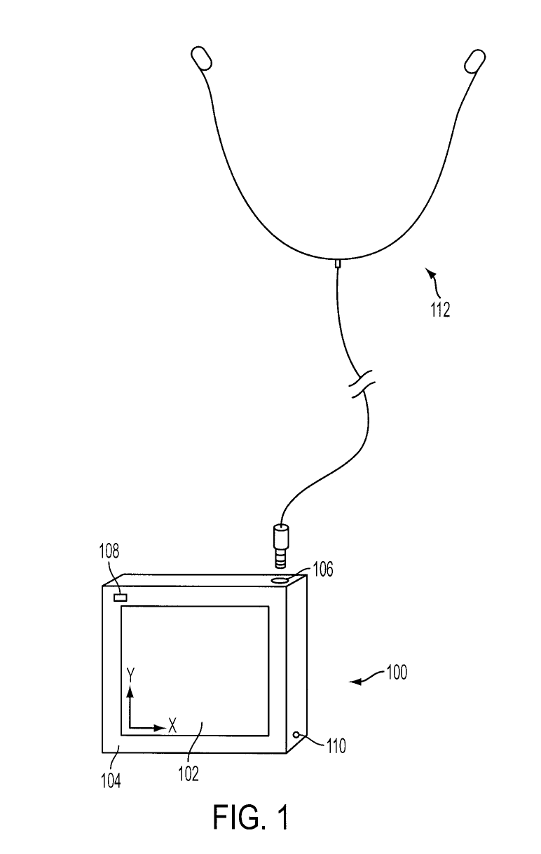

FIG. 1 is an illustrative electronic device in accordance with one embodiment of the present invention. Electronic device 100 can be a small form-factor media player similar, for example, to the iPod Shuffle™ (“Shuffle”) sold by Apple Inc. However, in contrast to some models of the Shuffle, electronic device 100 replaces the plurality of user input buttons in the Shuffle with fingerprint sensor 102. Fingerprint sensor 102 can be, for example, an optical sensor, an ultrasonic sensor, a passive capacitance sensor, an active capacitance sensor, or any combination thereof. Fingerprint sensor 102 also can be any other type of appropriate sensor known in the art or otherwise that can capture characteristics of a person's fingerprint.

In addition to fingerprint sensor 102, electronic device 100 also can have housing 104, audio jack 106, indicator light 108, and reset 110. Audio jack 106 can provide an interface through which device 100 can transmit audio signals to headphones 112 or another audio output device. Indicator light 108 can provide limited visual feedback to the user. For example, indicator light 108 can change colors depending on the battery life. Reset 110 can be a button (e.g., a pin-hole button) that causes the device to, for example, either reboot or reset to factory condition when actuated. The reset consequence can vary depending on the length of time the reset is actuated.

Electronic device 100 and/or headphones 112 also can incorporate additional features that are not shown in FIG. 1 to simplify the drawing. For example, electronic device 100 also can incorporate a data input through which data can be transmitted between an external source and the electronic device. Headphones 112 also can incorporate a microphone disposed along the headphone wires to acquire audio user input.

Although device 100 may include several fingerprint sensors 102, only one is shown in FIG. 1 to simplify the drawing. With multiple fingerprint sensors 102, an electronic device of the present invention can accept numerous additional fingerprint compositions and thus permit a user to control the device using numerous additional user-selectable commands.

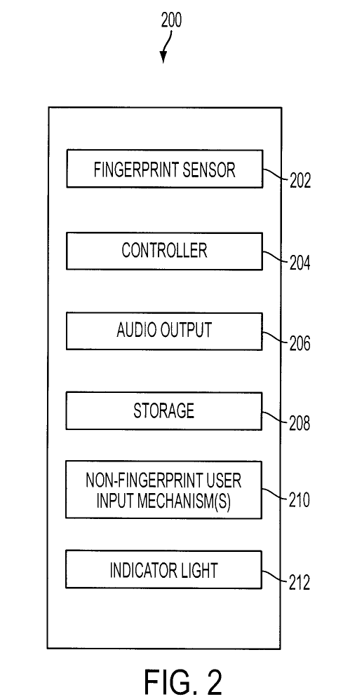

FIG. 2 is an illustrative block diagram of the electronic device of FIG. 1 in accordance with one embodiment of the present invention. Electronic device 100 can include some or all of the features of device 200. Device 200 can incorporate fingerprint sensor 202, controller 204, audio output 206, storage 208, one or more non-fingerprint user input mechanisms 210, indicator light 212, and any other suitable components. One or more of these components may reside externally or remotely. For example, fingerprint sensor 202, controller 204, storage 208, and/or user input mechanism(s) 210 can be provided as an external unit electrically coupled to device 200 and/or reside wholly or partially on a remote server. Each component of electronic device 200 referenced herein may include one or more hardware units and/or software. All of the applications employed by fingerprint sensor 202, audio output 206, storage 208, non-fingerprint user input mechanism(s) 210, and indicator light 212 can be interconnected and managed by controller 204.

Controller 204 may be operative to perform some or all of the operations of one or more applications implemented on device 200. Any suitable number or type of applications may be implemented. In some embodiments, device 200 may operate or assist in operating one or several applications to control device 200 using a person's fingerprints. For example, controller 204 can accept fingerprint data from fingerprint sensor 202 and match that data to fingerprint signatures stored in storage 208. Controller 204 may perform fingerprint recognition using any type of algorithm, including, for example, pattern-based algorithms and/or minutia-based algorithms. Pattern-based algorithms can compare the fingerprint patterns (e.g., whorls and loops) between a stored fingerprint signature and detected fingerprint(s). Minutia-based algorithm can compare several minutia points (e.g., ridges and bifurcations) extracted from a stored fingerprint signature with those extracted from detected fingerprint(s). The applications can be partially or wholly stored on the device and/or on a remote server. The applications also can be partially or wholly run by controller 204 and/or a controller of a remote server.

Audio output 206 may include any suitable audio component for providing audio to the user of device 200. For example, audio output 206 may include one or more speakers (e.g., mono or stereo speakers) built into device 200. In some embodiments, audio output 206 may include an audio component that is coupled to device 200. In one embodiment, the audio component can be, for example, a headset or headphones 112 that may be coupled to device 200 with wire(s) (as illustratively shown in FIG. 1) or wirelessly (e.g., using Bluetooth).

Storage 208 can store firmware (e.g., for device applications such as an operating system, user interface functions, and processor functions) and information related to other devices with which device 200 communicates. Storage 208 can include, for example, cache, Flash, ROM, and/or RAM. Storage 208 can include local and/or remote storage. For example, storage 208 can include both local ROM, RAM, and cache, and storage space on a remote server. Storage can have a database in which is stored associations of each user-selectable command to a user input signature. As discussed above and in greater detail below, each user input signature can include a sole fingerprint signature, multiple fingerprint signatures, or a combination of fingerprint and non-fingerprint signatures.

Non-fingerprint user input mechanism(s) 210 may be any suitable mechanism for providing user inputs or instructions to device 200, other than mechanisms that sense fingerprints. Input mechanism 210 may take a variety of forms, such as one or more buttons, keypads, dials, trackballs, sliders, clickwheels/scrollwheels, touch screens, and/or microphones. The user interface may emulate a multi-button keypad, which may be implemented on a touch screen or the combination of a clickwheel/scrollwheel or other user input device and a screen.

Electronic device 200 also can include additional features that are not shown in FIG. 2 to simplify the drawing. For example, device 200 also can include a battery, battery charger input, display, and/or communications circuitry for transmitting data between an external source and the electronic device.

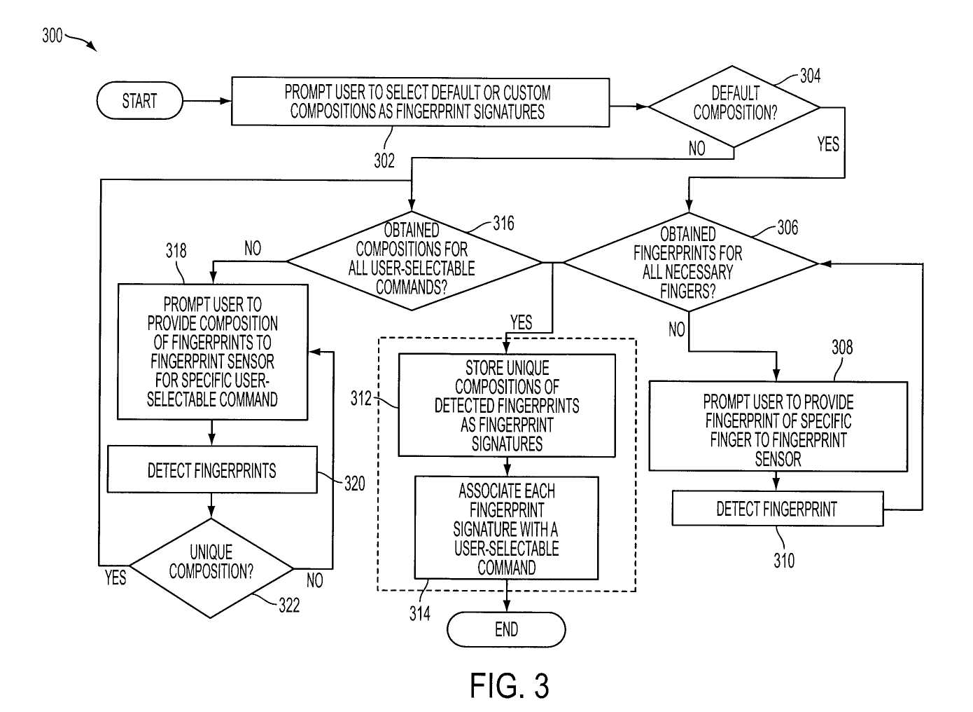

FIG. 3 is an illustrative registration process for associating unique compositions of a user's fingerprints with user-selectable commands in accordance with one embodiment of the present invention. The compositions of fingerprints can be stored as fingerprint signatures, each of which can be associated with a user-selectable command. Later, when the user wishes the device to initiate one of those commands, the user can provide to a fingerprint sensor the same fingerprint(s) associated with the desired command. In response to a positive match between the detected fingerprints and the appropriate fingerprint signature, the device can initiate the desired associated command. Illustrative embodiments of this process are described in greater detail below.

As used herein, a composition of fingerprints can include a group of one or more fingerprints. Each composition can include the fingerprint from one finger or fingerprints from multiple fingers. When a device has only one fingerprint sensor, compositions having multiple fingerprints can be entered by pressing one finger multiple times to the fingerprint sensor or by successively pressing different fingers to the fingerprint sensor.

At step 302, an electronic device of the present invention can visually or audibly prompt a user to elect to store default compositions of fingerprints as fingerprint signatures or to store custom compositions of fingerprints as fingerprint signatures.

If the user selects default compositions, the device can associate a unique, predetermined composition of the user's fingerprints to each user-selectable command. For example, the device can be configured to always associate the fingerprint from a user's index finger to indicate a first user-selectable command (e.g., play), the fingerprint from a user's middle finger to indicate a second user-selectable command (e.g., stop), the fingerprint from a user's ring finger to indicate a third user-selectable command (e.g., fast-forward), and the fingerprint from a user's pinky to indicate a fourth user-selectable command (e.g., rewind). The device also can be configured to associate multiple presentations of a fingerprint from a single predetermined finger (e.g., two successive presses from the index finger), a composition of fingerprints from different predetermined fingers (e.g., one press from the index finger immediately followed by one press from the middle finger), or a combination thereof.

For example, if the user selects default compositions, in step 308, the device can visually or audibly prompt the user to provide the fingerprint for a specific finger to fingerprint sensor 202. In step 310, the device can detect the fingerprint. In step 306, the device can determine whether the device has obtained fingerprints for all the necessary fingers. If not, the device again can prompt the user to provide the fingerprint of another specific finger and detect that fingerprint. This can occur iteratively until the device determines in step 306 that it has obtained fingerprints for all the necessary fingers.

Thereafter, in step 312, the device can store unique compositions of the detected fingerprints as fingerprint signatures in storage 208. As discussed above, the compositions of fingerprints stored as fingerprint signatures are predetermined in default compositions. That is, for each fingerprint signature, fingerprints of one or more predetermined fingers are stored. Then, in step 314, the device can associate each fingerprint signature with a user-selectable command and store that association in a database of storage 208. Again, in default compositions, the fingerprint signature associated with each command is predetermined. Thereafter, the registration process can end.

If the user selects custom compositions in step 304, the device can permit the user to customize the composition of the user's fingerprints associated to each user-selectable command. For example, while the device may always associate the fingerprint from a predetermined finger to a predetermined user-selectable command in a default composition, the device would permit the user to provide a unique composition of fingerprints to associate to each user-selectable command in a custom composition. Furthermore, like default compositions, the user can choose to customize compositions by indicating multiple presentations of a fingerprint from the same finger, a composition of fingerprints from different fingers, or a combination thereof.

For example, if the user selects custom compositions, in step 318, the device can visually or audibly prompt the user to provide a desired composition of fingerprints to fingerprint sensor 202 for a specific user-selectable command. At step 320, the device can detect the presented fingerprints. To ensure that the device has sufficient time to acquire sufficient data regarding the user's fingerprints before it proceeds to step 322, the device can be configured to visually or audibly notify the user when the device is in the process of collecting fingerprint data.

At step 322, the device can determine whether the user has provided a unique composition of fingerprints. For example, the device can compare the composition to those previously provided by the user during the registration process and temporarily stored in storage. If the composition is not unique, the device can return to step 318 to visually or audibly prompt the user to provide a unique composition of fingerprints. The device also can output a visual or audio error message. But, if the composition is unique, the device can proceed to step 316, in which it determines whether it has acquired unique fingerprint compositions for all user-selectable commands. If not, the device can repeat steps 318-322 until it has done so.

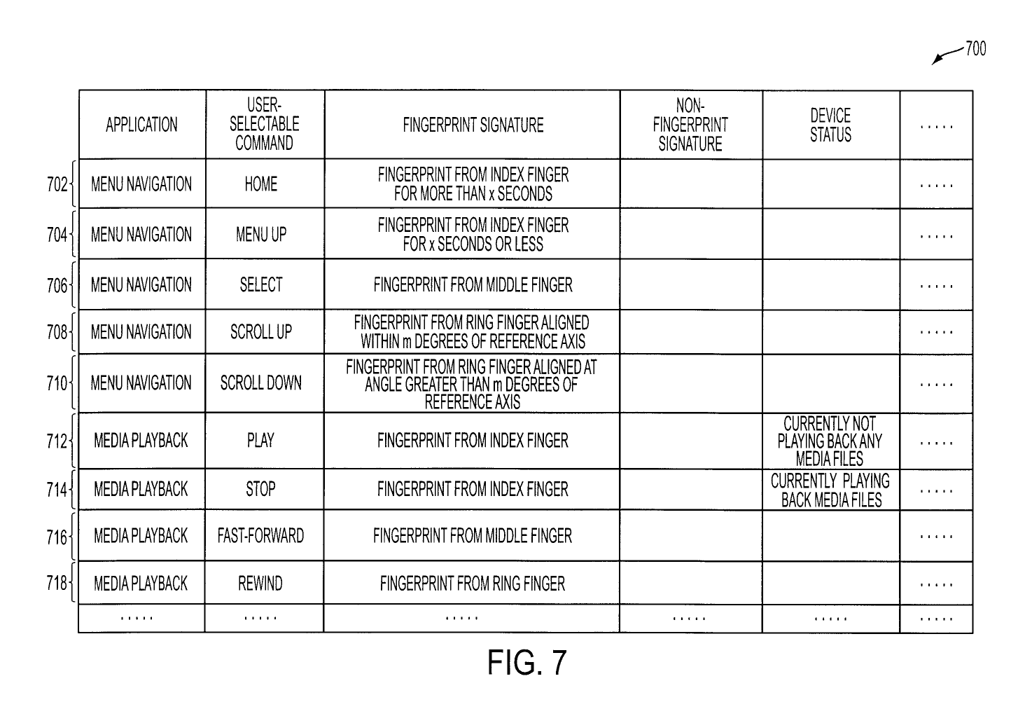

In some embodiments of the present invention, identical fingerprint compositions (or signatures) can be associated with different user-selectable commands. This can occur, for example, when the user input signatures have non-fingerprint signatures that are different, when user-selectable commands belong to different applications, and/or when one or more of the commands also is associated with device status (as discussed in greater detail with respect to FIG. 7). Applications can refer to types of activities (e.g., menu navigation), types of software programs (e.g., calendar, media playback, data acquisition from a different sensor, etc.), specific software programs (e.g., a specific game), or any other functions requiring user input. When identical fingerprint compositions (or signatures) can be associated with different user-selectable commands, step 322 can be adjusted accordingly to determine whether the combination of parameters associated with a user-selectable commands is unique. Examples of identical fingerprint signatures for different user-selectable commands illustratively are described in greater detail with respect to FIG. 7.

If the device has acquired fingerprint compositions for all user-selectable commands, it can proceed to steps 312 and 314, during which the device can store the compositions of detected fingerprints as fingerprint signatures associated with the appropriate user-selectable commands. Thereafter, the registration process can end.

While FIG. 3 has presented steps 312 and 314 as separate steps, a device of the present invention can perform both steps simultaneously. That is, the device can store unique compositions of the detected fingerprints in association with user-selectable commands. The stored compositions then serve as the fingerprint signatures. Indeed, in responding to step 318, the user has already indicated the desired association when providing fingerprints to the device.

In an alternative embodiment of the present invention, the device can confirm that the user has provided the appropriate or desired fingerprint compositions by repeating either steps 306-310 or steps 316-320 (depending on whether the user selected default or custom fingerprint compositions). If the device cannot confirm that it acquired the appropriate or desired fingerprint compositions (e.g., one or more of the confirmation fingerprints does not match that previously acquired during the registration process), the device can repeat the registration process.

In embodiments of the present invention in which the user input signature includes both fingerprint and non-fingerprint signatures, process 300 may be augmented by one or more steps to accommodate acquisition of the non-fingerprint signature. For example, one or more of the following steps may be added: (1) prompt the user to provide non-fingerprint user input to store as a non-fingerprint signature, (2) detect such user input, (3) store the detected non-fingerprint user input as the non-fingerprint signature, and (4) associate the non-fingerprint signature to a user-selectable command.

In some embodiments of the present invention, different user-selectable commands can be associated to the same user input. For example, this can occur when the commands belong to different applications and/or the command also is associated with a device status (as discussed in more detail with respect to FIG. 7). Thus, in one embodiment of the present invention, a user input signature is unique when it is not identical to another user input signature associated with a user-selectable command of the same application and/or associated with the same device status.

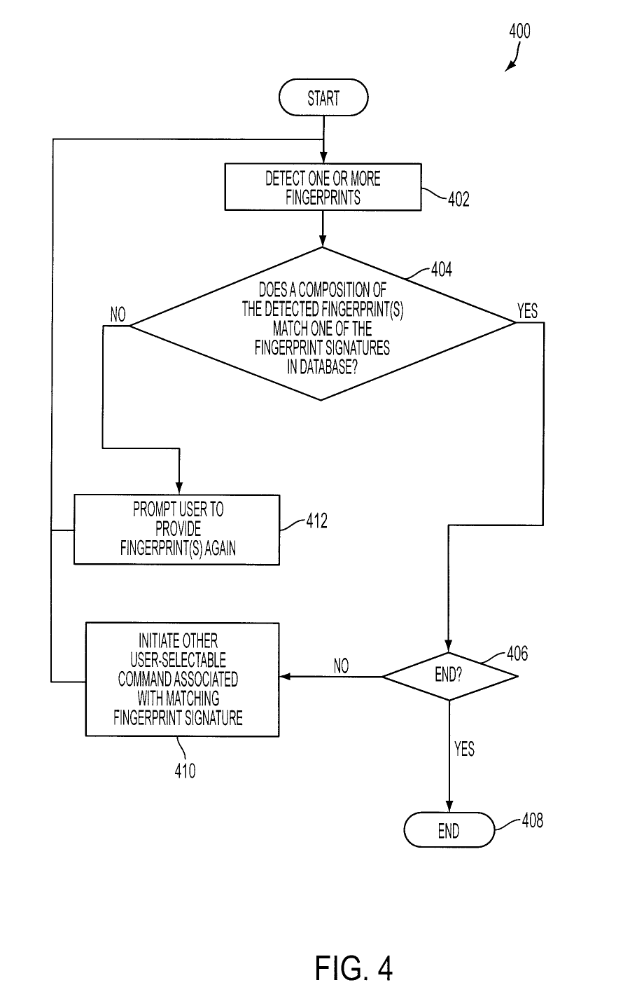

FIG. 4 is an illustrative process for controlling an electronic device using a person's fingerprints in accordance with one embodiment of the present invention. In step 402, the device can detect one or more fingerprints presented to fingerprint sensor 202. In step 404, the device can determine whether a composition of the detected fingerprints matches one of the fingerprint signatures stored at step 312 of FIG. 3. If so, in step 406, the device can check whether the associated user-selectable command is a command to turn off the device. If so, the device can proceed to step 408, in which the process ends. However, if the associated user-selectable command is not a command to turn off the device, the device can proceed to step 410, during which it can initiate the user-selectable command associated with the matching fingerprint signature. Thereafter, the device can return to step 402 to await and detect additional fingerprints.

If, at step 404, the device determines that a composition of the detected fingerprints does not match any one of the fingerprint signatures stored in the database, it can proceed to step 412. At step 412, the device can visually or audibly prompt the user to provide the fingerprint(s) again. The device then can return to the beginning of process 400 to attempt to detect the presented fingerprints and match the detected fingerprints to a fingerprint signature.

In accordance with one aspect of the present invention, the device also can provide audio, visual, or haptic feedback to the user when it identifies a user-selectable command that matches user input. For example, prior to initiating a user-selectable command in steps 508 or 512, the device can audially output the name of the identified command through audio output 206. The device then can request confirmation from the user that the identified command is what the user intended or immediately initiate the identified user-selectable command. The device also can visually output the name of the identified command (e.g., using a display) or cause a light indicator to change its illumination. The device also can vibrate once it has identified a user-selectable command associated with the user input.

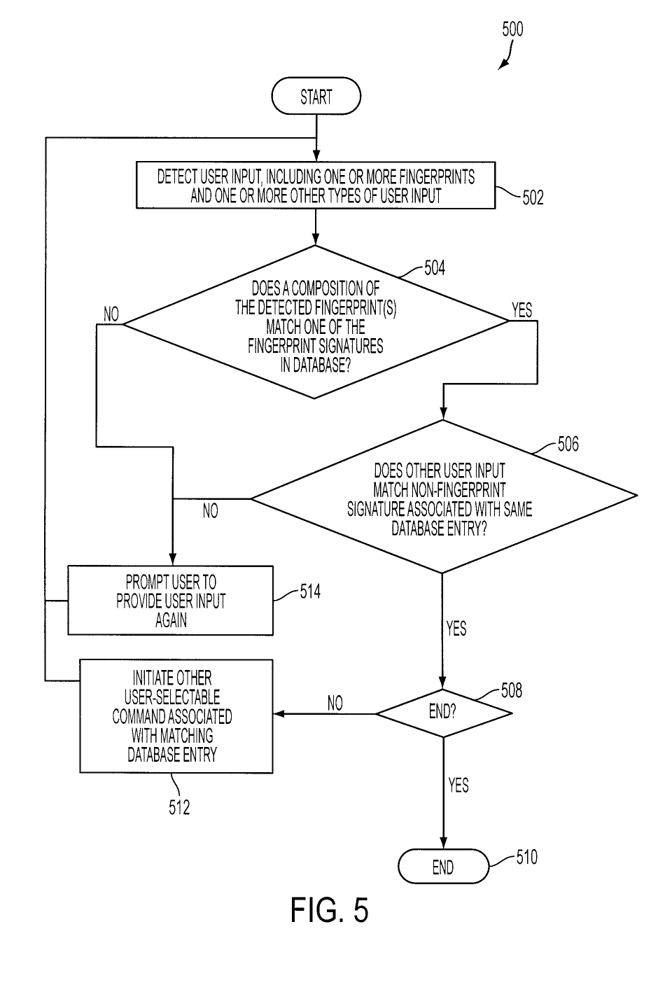

FIG. 5 is an illustrative process for controlling an electronic device using a person's fingerprints and other user input in accordance with one embodiment of the present invention. In contrast to process 400 of FIG. 4, this process can be implemented when the user input signature includes both fingerprint and non-fingerprint signatures.

In step 502, the device can detect user input, including one or more fingerprints presented to fingerprint sensor 202 and one or more other types of user inputs presented to non-fingerprint user input mechanism(s) 210. In step 504, the device can determine whether a composition of the detected fingerprints matches one of the fingerprint signatures stored at step 312 of FIG. 3. If so, in step 506, the device can determine whether the other detected user input matches the non-fingerprint signature associated with the same database entry identified in step 504. If so, in step 508, the device can check whether the associated user-selectable command is a command to turn off the device. If so, the device can proceed to step 510, in which the process ends. However, if the associated user-selectable command is not a command to turn off the device, the device can proceed to step 512, during which it can initiate the user-selectable command associated with the matching fingerprint and non-fingerprint signatures. Thereafter, the device can return to step 502 to await and detect additional user input.

If, at step 504 or step 506, the device determines that the user input detected in step 502 does not match any one of the user input signatures stored in the database, it can proceed to step 514. In step 514, the device can visually or audibly prompt the user to provide the user input again. The device then can return to the beginning of process 500 to attempt to detect the presented user input and match the detected user input to a user input signature.

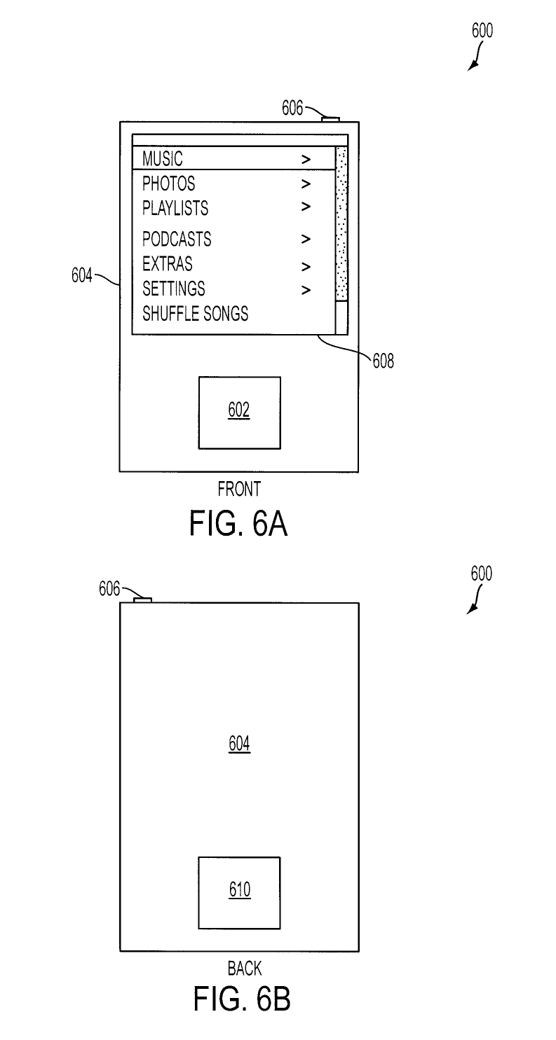

FIGS. 6A and 6B show a second illustrative electronic device in accordance with one embodiment of the present invention. Electronic device 600 can be a media player similar, for example, to the iPod Nano™ (“Nano”) or iPod Classic™ (“Classic”) sold by Apple Inc. However, in contrast to some models of the Nano and Classic, electronic device 600 can replace the buttons and/or clickwheel/scrollwheel with fingerprint sensor 602 in accordance with the present invention. In addition to fingerprint sensor 602, electronic device 600 also can have housing 604, audio jack 606, and display 608.

Electronic device 600 also can incorporate second fingerprint sensor 610 for accepting an activation fingerprint. When electronic device 600 does not detect an activation fingerprint, the device can be configured to ignore fingerprints presented to fingerprint sensor 602. Thus, if a user accidentally presses a fingerprint to sensor 602, device 600 will not change states. When electronic device 600 does detect the activation fingerprint, however, the device can unlock itself to accept fingerprints presented to sensor 602. In one embodiment of the present invention, the activation fingerprint can be the fingerprint corresponding to a user's thumb. Device 600 can register the activation fingerprint during registration process 300 of FIG. 3. In an alternative embodiment of the present invention, second fingerprint sensor 610 can be replaced by a button or latch that, when depressed, unlocks the device to accept fingerprints presented to fingerprint sensor 602.

FIG. 7 is an illustrative database in which user-selectable commands are associated with different parameters in accordance with one embodiment of the present invention. Each user-selectable command can be associated with one or more parameters, including, for example, application, fingerprint signature, non-fingerprint signature, and device status. When the fingerprint signature of two or more user-selectable commands are identical, a device of the present invention can differentiate between or among the commands by evaluating one or more of the other parameters to which the commands are associated.

For example, in some embodiments, user-selectable commands can be associated with a non-fingerprint signature and/or a device status, particularly when the fingerprint signatures for two user-selectable commands in the same application are identical. For example, as shown in entries 712 and 714 of database 700, during the media playback application, the device can be configured such that a user can initiate both the play and stop commands by presenting the fingerprint from his index finger. However, the device can determine which of the two commands to actually initiate by considering the device status. That is, if the device currently is not playing back any media files, the device can assume that the user wants to initiate the play command when he presents the fingerprint from his index finger. But, if the device currently is playing back a media file, the device can assume that the user wants to initiate the stop command instead.

In accordance with another aspect of the present invention, identical fingerprint signatures can be associated with different user-selectable commands when the user-selectable commands belong to different applications. For example, as shown in entries 706 and 716, the fingerprint signature for selecting a menu entry during menu navigation can be identical to the fingerprint signature for fast-forwarding during media playback. In order for the device to determine which command the user intends when it presents the fingerprint for his middle finger, the device can consider the currently active application. Likewise, as shown in entries 708 and 718, the fingerprint signature for scrolling up during menu navigation can be identical to the fingerprint signature for rewinding during media playback.

In accordance with yet another aspect of the present invention, fingerprint signatures also can incorporate a time element. For example, according to entries 702 and 704, the device can expect the user to present the fingerprint from his index finger to initiate both user-selectable commands: “home” and “menu up.” To differentiate the two commands, the device can detect the length of time the user presses his index finger to the fingerprint sensor. If the device detects that the user presses his index finger to the fingerprint sensor for more than an x amount of time, the device can assume that the user intends the device to go to its “home” menu. But, if the device detects that the user presses his finger to the fingerprint sensor for x seconds or less, then the device can assume that the user intends the device to only go up one menu level.

In accordance with yet another aspect of the present invention, fingerprint signatures also can incorporate an orientation element. For example, as shown in entries 708 and 710 of database 700, the device can be configured such that a user can initiate both the “scroll up” and “scroll down” commands by presenting the fingerprint from his ring finger. The device can determine which of the two commands to actually initiate by considering the orientation of the fingerprint detected by the fingerprint sensor. That is, if the fingerprint is aligned within m degrees of a reference axis (e.g., within 30 degrees of the y-axis of FIG. 1), then the device can assume that the user wants to initiate the “scroll up” command. But, if the fingerprint is aligned at an angle greater than m degrees from the reference axis (e.g., more than 30 degrees from the y-axis of FIG. 1), the device can assume that the user wants to initiate the “scroll down” command instead.

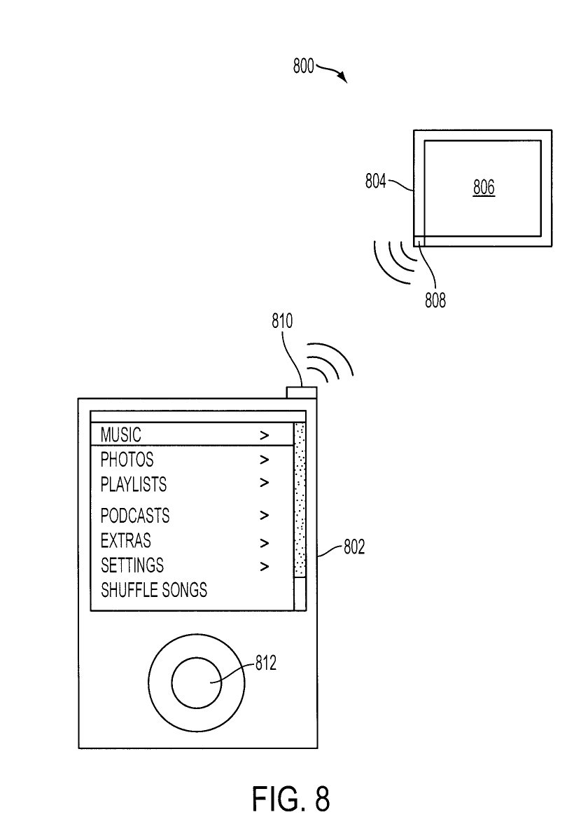

FIG. 8 shows an illustrative electronic system in accordance with one embodiment of the present invention. In contrast to some embodiments of the present invention in which fingerprint sensor(s) can be integrated into the electronic device that it controls, a system of the present invention also can be configured to have a remote fingerprint sensing device that can control a host device. The remote fingerprint sensing device can communicate with the host device via a wireless or wired communication link. For example, in the embodiment shown in FIG. 8, system 800 can include host device 802 and remote control device 804, which can be configured to transmit control signals to host device 802. Host device 802 can, for example, be a media player similar to the Nano or Classic sold by Apple Inc.

In accordance with the present invention, fingerprint sensor(s) 806 can be remotely disposed within remote control device 804. Fingerprint sensor(s) 806 can detect a person's fingerprints and send such data to host device 802 via either a wireless communications link or a wired communications link. The controller in the host device then can perform the processing required to match the fingerprint(s) to a fingerprint signature. In one embodiment of the present invention, remote control device 804 can transmit fingerprint data to host device 802 via antennas 808 and 810 using a wireless communications protocol (e.g., Bluetooth).

Remote control device 804 also can be integrated with an accessory for host device 802 (e.g., a headset or headphones). The remote control device can be configured to transmit fingerprint data to host device 802 using wire(s) that connect the accessory to the host device or using antennas. The wire(s) or antennas can be dedicated to transmitting fingerprint data or can transmit additional types of data.

In one embodiment of the present invention, remote control device 804 can be provided as an accessory input device to host device 802. In particular, host device 802 can be a fully-contained device having an integrated user input mechanism 812. Thus, remote control device 804 can provide additional modes of user input in addition to or in lieu of the modes of user input offered by integrated user input mechanism 812.

In accordance with another aspect of the present invention, a user's fingerprints can be used for authentication purposes, in addition to controlling operation of the device. For example, in process 400 and 500, steps can be added to determine whether any of the detected fingerprints match (1) any of the fingerprints stored in the fingerprint signatures, (2) a composition of fingerprints dedicated to authentication purposes, or (3) the activation fingerprint presented to fingerprint sensor 610 of FIG. 6B. If any of the detected fingerprint(s) match, then a positive authentication determination can be made.

Alternatively, steps can be added to determine whether any of the detected fingerprint(s) do not match (1) any of the fingerprints stored in the fingerprint signatures, (2) a composition of fingerprints dedicated to authentication purposes, or (3) the activation fingerprint. If any of the detected fingerprints do not match, then a positive authentication determination can be made.

Responsive to a positive authentication determination, a device of the present invention can permit a user to access one or more functions of the electronic device and/or stored content (e.g., stored media content). This can be useful to prevent unauthorized use of the device. This also can be useful when one or more functions of the device and/or content stored in the device is distributed to users on a per license basis.

The present invention can be employed in any electronic device or system that permit user control, including any portable, mobile, hand-held, or miniature consumer electronic device. Illustrative electronic devices or systems can include, but are not limited to, music players, video players, still image players, game players, other media players, music recorders, video recorders, cameras, other media recorders, radios, medical equipment, calculators, cellular phones, other wireless communication devices, personal digital assistances, programmable remote controls, pagers, laptop computers, printers, computer mice, other computer accessories, cars or portions thereof, or any combination thereof. Miniature electronic devices may have a form factor that is smaller than that of hand-held devices. Illustrative miniature electronic devices can include, but are not limited to, watches, rings, necklaces, belts, accessories for belts, headsets, accessories for shoes, virtual reality devices, other wearable electronics, accessories for sporting equipment, accessories for fitness equipment, key chains, or combinations thereof.

Although particular embodiments of the present invention have been described above in detail, it will be understood that this description is merely for purposes of illustration. Alternative embodiments of those described hereinabove also are within the scope of the present invention. For example, FIGS. 3-5 only present illustrative flowcharts in accordance with some embodiments of the present invention. One or more of the steps described with respect to those figures can be removed, consolidated, or reordered without departing from the present invention.

Also, any combination of the above-described embodiments also is within the scope of the present invention. For example, user-selectable commands can be associated with fingerprint signatures having both time and orientation elements, in addition to or in lieu of non-fingerprint signatures, device status, and/or application.

Furthermore, while the processes described above illustratively register, detect, and respond to the fingerprints of one user per device, a device of the present invention can be configured to register, detect, and respond to the fingerprints of multiple users.

The above described embodiments of the present invention are presented for purposes of illustration and not of limitation, and the present invention is limited only by the claims which follow.

What is claimed is:

1. An electronic system comprising:
one or more user input mechanisms for detecting user input, the one or more user input mechanisms comprising one or more fingerprint sensors for detecting fingerprints;
storage for storing a database in which each of a plurality of user-selectable commands is associated with a user input signature, wherein a first user input signature comprises a fingerprint signature; and
a controller configured to:
determine whether a composition of detected fingerprints matches the fingerprint signature; and
initiate a user-selectable command associated with the first user input signature responsive to a positive match between detected user input and the first user input signature.

2. The electronic system of claim 1, wherein:
the one or more user input mechanisms comprises one or more non-fingerprint user input mechanisms;
the first user input signature comprises a fingerprint signature and a non-fingerprint signature, the non-fingerprint signature related to user input detectable by the one or more non-fingerprint user input mechanisms; and
the controller further is configured to determine whether user input detected by the one or more non-fingerprint user input mechanisms matches the non-fingerprint signature.

3. The electronic system of claim 1, wherein the electronic device is configured to use one or more of the detected fingerprints for authentication purposes.

4. The electronic system of claim 3, wherein the controller is configured to permit access to one or more functions of the electronic device responsive to a positive authentication determination.

5. The electronic system of claim 3, wherein the controller is configured to permit access to stored content responsive to a positive authentication determination.

6. The electronic system of claim 1, wherein the electronic device comprises a media player.

7. The electronic system of claim 1, wherein the fingerprint signature incorporates a time element.

8. The electronic system of claim 1, wherein the first user input signature is identical to a second user input signature, wherein the first and second user input signatures are associated with two different user-selectable commands.

9. The electronic system of claim 1, wherein the one or more fingerprint sensors are remotely disposed in a remote control device and the controller is disposed in a host device.

10. The electronic system of claim 1, wherein the one or more fingerprint sensors and the controller are disposed within a single housing.

11. An electronic device comprising:
one or more fingerprint sensors for detecting fingerprints;
storage; and
a controller configured to:
cause the storage to store a plurality of compositions of detected fingerprints as a plurality of fingerprint signatures; and
associate each of the plurality of fingerprint signatures with one of a plurality of user-selectable commands.

12. The electronic device of claim 11, wherein the controller further is configured to prompt a user to provide one or more fingerprints to the one or more fingerprint sensors.

13. The electronic device of claim 11, wherein the electronic device is configured to permit a user to customize at least one of the plurality of compositions stored as the plurality of fingerprint signatures.

14. The electronic device of claim 11, wherein the electronic device is configured to store a default composition as at least one of the plurality of fingerprint signatures.

15. The electronic device of claim 11, wherein the controller is configured to:
determine whether a composition of detected fingerprints matches a first fingerprint signature from the plurality of fingerprint signatures; and
initiate a user-selectable command associated with the first fingerprint signature responsive at least in part to a positive match between the composition of detected fingerprints and the first fingerprint signature.

16. The electronic device of claim 11, wherein at least one of the plurality of fingerprint signatures incorporates a time element.

17. The electronic device of claim 11, wherein at least one of the plurality of fingerprint signatures incorporates an orientation element.

18. A method for controlling an electronic device, the method comprising:
detecting user input, wherein the user input comprises one or more fingerprints detectable by one or more fingerprint sensors;
determining whether the detected user input matches one of a plurality of user input signatures, wherein a first user input signature comprises a fingerprint signature; and
initiating a user-selectable command associated with the first user input signature responsive to a positive match between the detected user input and the first user input signature.

19. The method of claim 18, wherein the first user input signature comprises a fingerprint signature and a non-fingerprint signature, the non-fingerprint signature related to user input detectable by one or more non-fingerprint user input mechanisms.

20. The method of claim 18, further comprising using one or more of the detected fingerprints for authentication purposes.

21. The method of claim 20, further comprising permitting access to one or more functions of the electronic device responsive to a positive authentication determination.

22. The method of claim 20, further comprising permitting access to stored content responsive to a positive authentication determination.

23. A method for controlling an electronic device, the method comprising:
detecting fingerprints;
storing a plurality of compositions of the detected fingerprints as a plurality of fingerprint signatures; and
associating each of the plurality of fingerprint signatures with one of a plurality of user-selectable commands.

24. The method of claim 23, further comprising permitting a user to customize at least one of the plurality of compositions stored as the plurality of fingerprint signatures.

25. The method of claim 23, wherein storing a plurality of compositions of the detected fingerprints as a plurality of fingerprint signatures comprises storing a default composition as at least one of the plurality of fingerprint signatures.
